(19) United States
(12) Patent Application Publication
(10) Pub. No.: US 2013/0208612 A1
(43) Pub. Date: Aug. 15, 2013

(54) METHODS AND SYSTEMS FOR INTERFERENCE MITIGATION IN WIRELESS LOCAL AREA NETWORKS

(71) Applicant: GO NET SYSTEMS LTD., (US)

(72) Inventors: Moshe Salhov, Herzeliya (IL); Gal Zuckerman, Holon (IL); Roy Kinamon, Tel Aviv (IL)

(73) Assignee: GO NET SYSTEMS LTD., Tel Aviv (IL)

(21) Appl. No.: 13/765,164

(22) Filed: Feb. 12, 2013

Related U.S. Application Data
(60) Provisional application No. 61/597,795, filed on Feb. 12, 2012.

(51) Int. Cl. H04W 24/02

(52) U.S. Cl. CPC H04W 24/02
USPC 370/252

(57) ABSTRACT

Disclosed are methods, circuits, apparatus, systems and associated computer executable code for mitigating interface signals interfering with operation of a wireless network.

### CROSS-REFERENCE TO RELATED APPLICATIONS

This application claims the benefit of U.S. Provisional Application No. 61/597,795, filed on Feb. 12, 2012, which is incorporated herein by reference in its entirety.

### BACKGROUND

Interferences between different wireless-local-area-networks are common, and may result in significant degradation in performance for at least some nodes associated with such networks. In a case of different wi-fi wireless-local-area-networks operating on the same frequency band, such interferences may result in reduced transmission rates and increased latency. Interferences may exist between different wireless access points of different wireless-local-area-networks, between a wireless access point and clients of different wireless-local-area-networks, or among clients of different wireless-local-area-networks.

### SUMMARY

The present invention includes methods, circuits, apparatus, systems and associated computer executable code for mitigating interface signals interfering with operation of a wireless network. According to some embodiments, persistent interference signal sources outside the wireless network are identified, a spatial filter is calculated and an interference mitigating beam is generated in accordance with the calculated spatial filter. According to some embodiments, the identification, calculation and/or beam generation may be performed by one or more circuits integral or otherwise functionally associated with an access point of the wireless network. According to further embodiments, the identification, calculation and/or beam generation may be performed by one or more circuits integral or otherwise functionally associated with a client device or other device associated with the wireless network.

According to some embodiments, the interference source may be a an access point or wireless client device associated with a second wireless network. According to yet further embodiments, the interference signal source may be a persistent emitter of radio frequency noise, for example an electric motor, high frequency switching circuit, etc.

In some embodiments, a wireless communication system operative to reduce interferences between different wireless local area networks includes: a wireless access point operative to set-up a first wireless-local-area-network, and a plurality of antennas belonging to said wireless access point. Said wireless access point is further operative to: (a) collect, via said plurality of antennas, wireless signal samples associated with (i) transmissions of at least a first transmitter associated with said first wireless-local-area-network, and (ii) transmissions of at least a second transmitter associated with a second wireless-local-area-network, (b) identify (i) a first subset of said wireless signal samples as being associated with said first wireless-local-area-network, and (ii) a second subset of said wireless signal samples as being non-associated with said first wireless local area network, (c) calculate a spatial filter using spatial information present in said second subset of said wireless signal samples, and (d) generate, using said plurality of antennas and said spatial filter, a beam operative to reduce wireless interferences generated by said second transmitter, thereby reducing interferences between said first and second wireless-local-area-networks.

In some embodiments, a method for long-term interference mitigation in wireless local area networks includes: (a) collecting via a plurality of antennas, by a transceiver associated with a first wireless-local-area-network, wireless signal samples associated with (i) transmissions of at least a first transmitter associated with said first wireless-local-area-network, and (ii) transmissions of at least a second transmitter associated with a second wireless-local-area-network, (b) identifying, by said transceiver, (i) a first subset of said wireless signal samples as being associated with said first wireless-local-area-network, and (ii) a second subset of said wireless signal samples as being non-associated with said first wireless local area network, (c) calculating a spatial filter by said transceiver, using spatial information present in said second subset of said wireless signal samples, and (d) generating, by said transceiver, using said plurality of antennas and said spatial filter, a beam operative to reduce wireless interferences generated by said second transmitter, thereby improving operation of said first wireless-local-area-network.

### BRIEF DESCRIPTION OF THE DRAWINGS

The embodiments are herein described, by way of example only, with reference to the accompanying drawings. No attempt is made to show structural details of the embodiments in more detail than is necessary for a fundamental understanding of the embodiments. In the drawings:

FIG. 1A illustrates an exemplary embodiment of a wireless communication system operative to reduce interferences between different wireless local area networks;

FIG. 1B illustrates an exemplary embodiment of a wireless communication system operative to reduce interferences between different wireless local area networks;

FIG. 1C illustrates an exemplary embodiment of a wireless communication system operative to reduce interferences between different wireless local area networks;

FIG. 1D illustrates an exemplary embodiment of transmissions;

FIG. 2A illustrates an exemplary embodiment of a wireless access point 101;

FIG. 2B illustrates an exemplary embodiment of a wireless access point 101; and

FIG. 3 illustrates an exemplary embodiment of a method for long-term interference mitigation in wireless local area networks.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

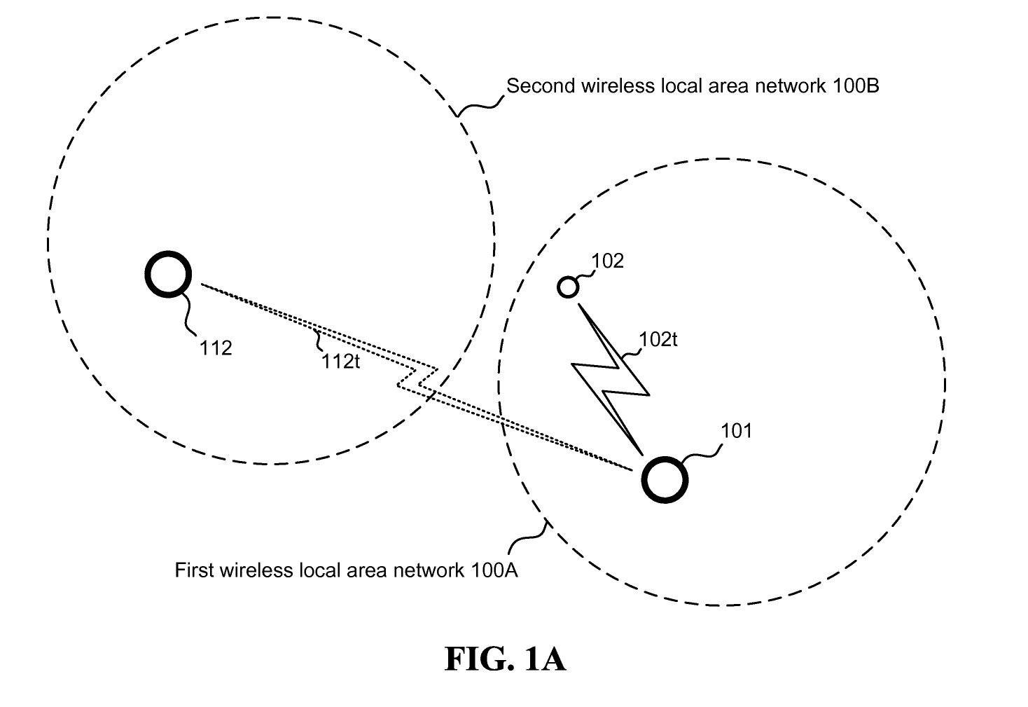

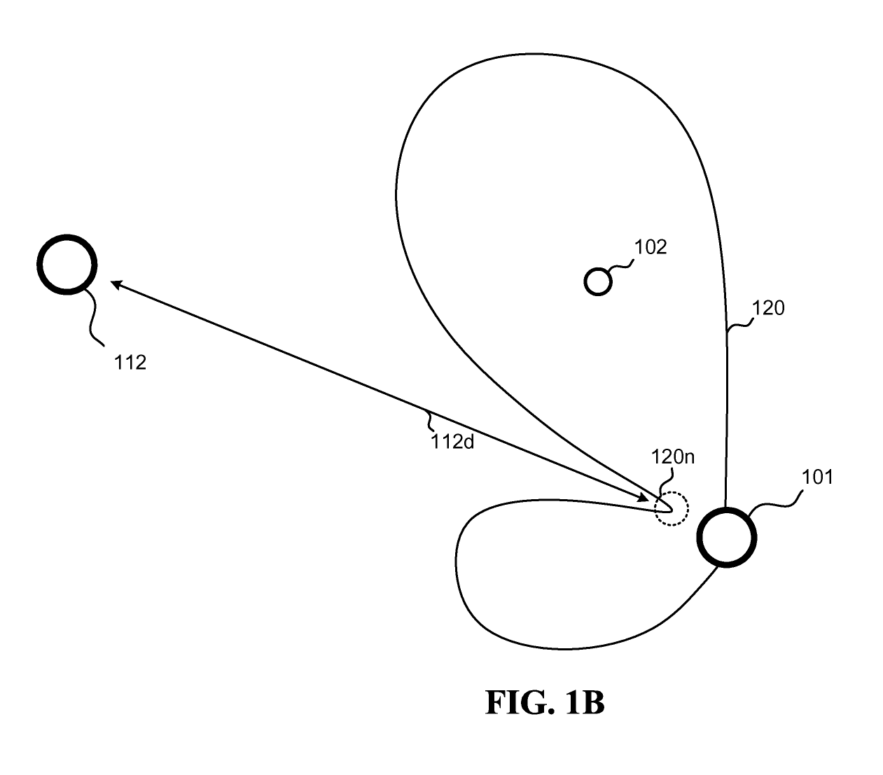

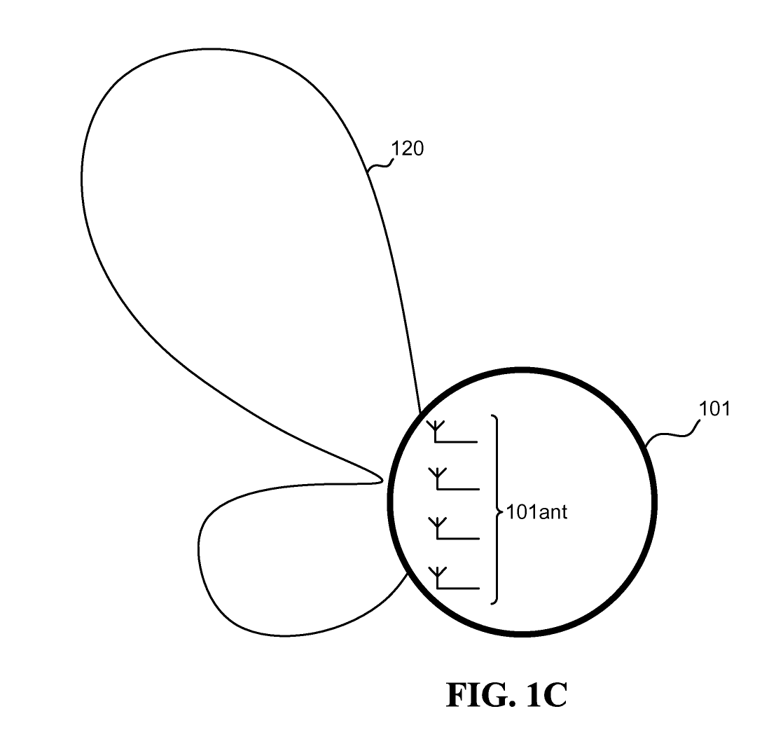

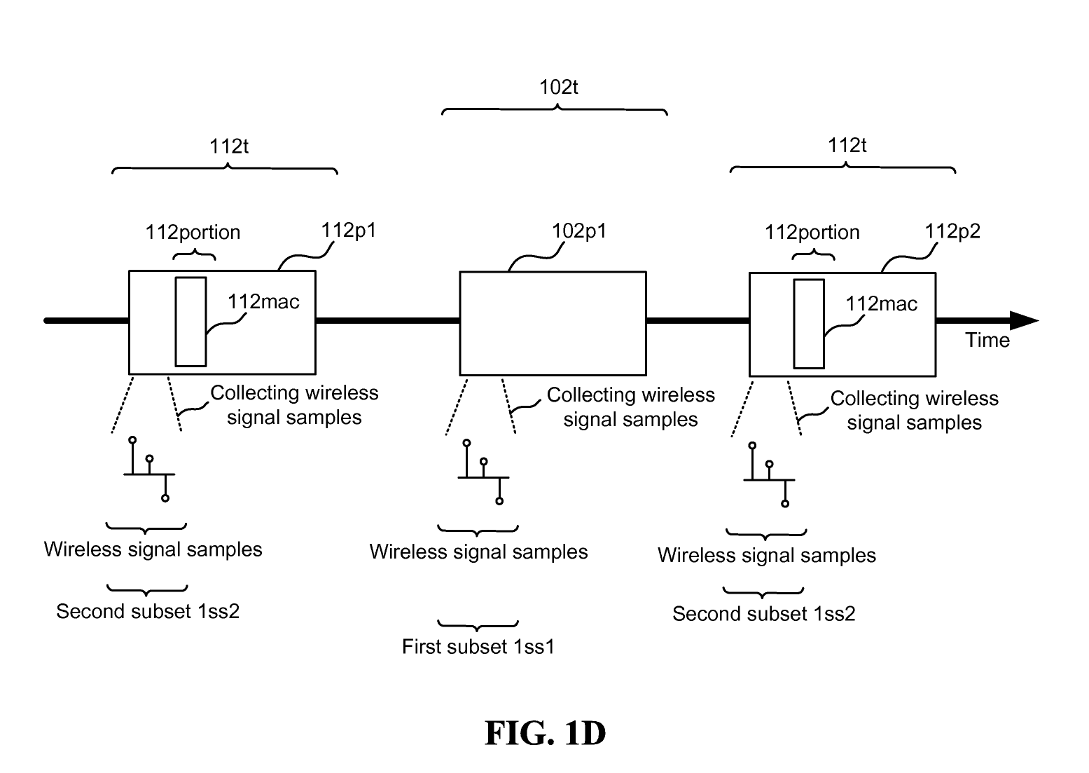

FIG. 1A, FIG. 1B, FIG. 1C, and FIG. 1D illustrate some embodiments of a wireless communication system operative to reduce interferences between different wireless local area networks 100A, 100B. In one embodiment, a wireless access point 101 sets-up a first wireless-local-area-network 100A. Wireless access point 101 includes a plurality of antennas 101ant. Wireless access point 101 collects, via said plurality of antennas 101ant, wireless signal samples associated with (i) transmissions 102t of at least a first transmitter 102 associated with said first wireless-local-area-network 100A, and (ii) transmissions 112t of at least a second transmitter 112 associated with a second wireless-local-area-network 100B. Wireless access point 101 then identifies: (i) a first subset 1ss1 of said wireless signal samples as being associated with said first wireless-local-area-network 100A, and (ii) a second subset 1ss2 of said wireless signal samples as being non-associated with said first wireless local area network 100A. Wireless access point 101 then calculates a spatial filter using spatial information present in said second subset 1ss2 of said wireless signal samples, and generates, using said plurality of antennas 101ant and said spatial filter, a beam 120 operative to reduce wireless interferences generated by said second transmitter 112, thereby reducing interferences between said first 100A and second 100B wireless-local-area-networks.

In one embodiment, said second subset 1ss2 of said wireless signal samples is arranged as an observation matrix comprising spatial information associated with said second transmitter 112, and said calculation is performed as follows: (i) a covariance is derived from said observation matrix, (ii) an existing codebook is adapted to an adapted codebook using said covariance, and (iii) said adapted codebook is used as the spatial filter. In one embodiment, a minimum-mean-square-error technique is applied on said second subset 1ss2 of said wireless signal samples by said calculation of said spatial filter.

In one embodiment, said first 100A and second 100B wireless-local-area-networks are wi-fi networks operating based on 802.11 standards. In one embodiment, wireless access point 101 to determines that said second subset 1ss2 of said wireless signal samples is associated with a 802.11 media-access-control address that does not belong to any device currently associated with said first wireless-local-area-network 100A, thereby facilitating said identification. In one embodiment, second transmitter 112 is a wireless wi-fi client. In one embodiment, second transmitter 112 is a second wireless access point. In one embodiment, first transmitter 102 is a wireless wi-fi client.

In one embodiment, said spatial information is associated with a direction 112d in which second transmitter 112 is positioned relative to said wireless access point 101 when said collection is made, and said generation results in a beam 120 comprising a null 120n directed 112d toward second transmitter 112, thereby reducing interferences between first 100A and second 100B wireless-local-area-networks. In one embodiment, said plurality of antennas 101ant are arranged as a phased array that captures said spatial information via said wireless signal samples and generates said beam 120 comprising said null 120n.

In one embodiment, the first 102 and second 112 transmitters receive and decode wireless-local-area-network transmissions, and wireless-local-area-network transmissions of wireless access point 101 intended for the first transmitter 102 are attenuated when received by the second transmitter 112 due to said generation of beam 120, thereby reducing interferences between said first 100A and second 100B wireless-local-area-networks. In one embodiment, wireless access point 101 receives and decodes wireless-local-area-network transmissions, and wireless-local-area-network transmissions of second transmitter 112 are attenuated when received by wireless access point 101 due to said generation of beam 120, thereby reducing interferences between said first 100A and second 100B wireless-local-area-networks.

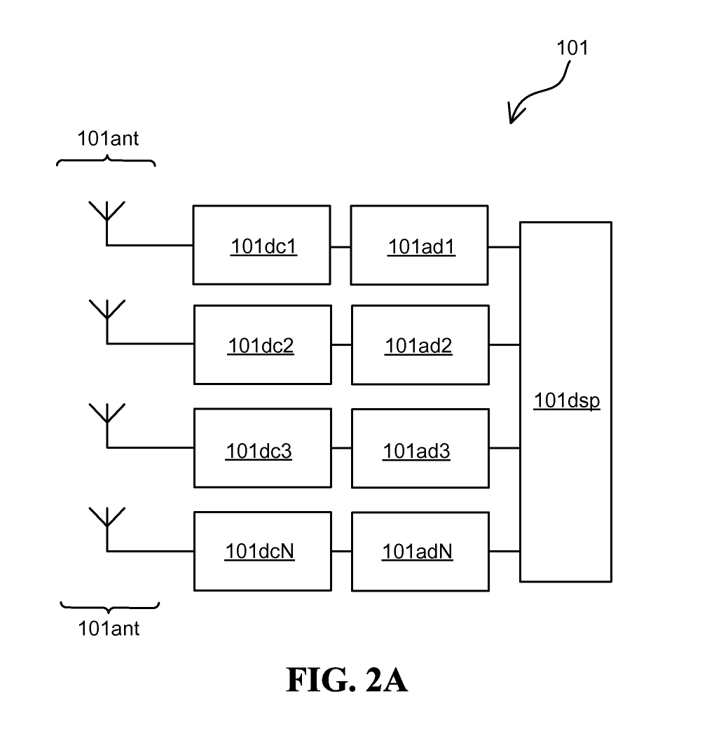

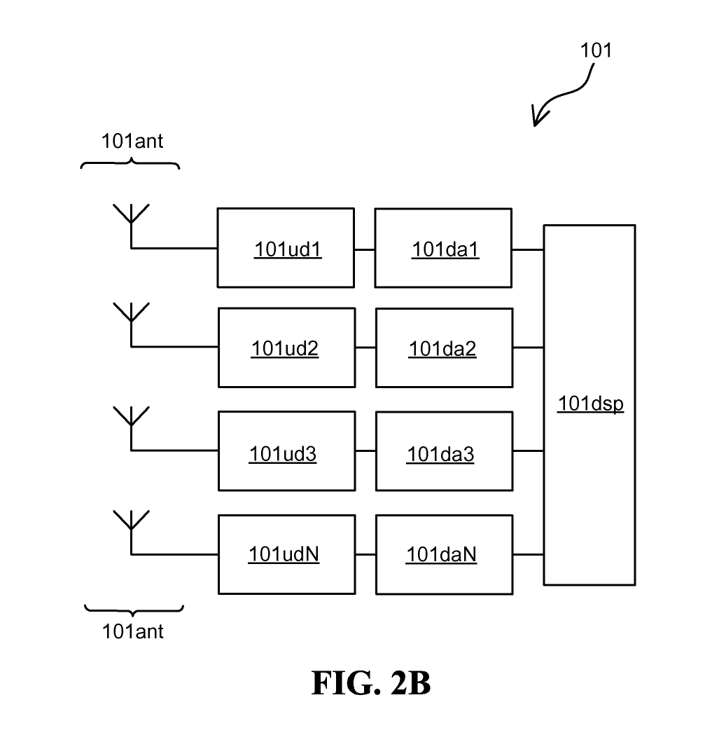

FIG. 2A and FIG. 2B illustrate some embodiments of wireless access point 101. In one embodiment, wireless access point 101 includes a digital-signal-processor 101dsp operative to perform said calculation and generate beam 120 using said spatial filter. In one embodiment, wireless access point 101 includes a plurality of radio-frequency down-converters 101dcl, 101dc2, 101dc3, 101dcN, connected to said plurality of antennas 101 and respectively and operative to (i) collect said wireless signal samples and (ii) participate in said generation of beam 120 when wireless access point 101 is in reception mode. In one embodiment, wireless access point 101 includes a plurality of analog-to-digital converters 101ad1, 101ad2, 101ad3, 101adN, connected to said plurality of radio-frequency down-converters 101dc1, 101dc2, 101dc3, 101dcN respectively. Said plurality of analog-to-digital converters 101ad1, 101ad2, 101ad3, 101adN are operative to (i) collect said wireless signal samples and (ii) feed said wireless signal samples into said digital-signal-processor 101dsp. In one embodiment, wireless access point 101 includes a plurality of analog-to-digital converters 101ad1, 101ad2, 101ad3, 101adN connected to said plurality of radio-frequency down-converters 101dc1, 101dc2, 101dc3, 101dcN respectively and operative to participate in said generation of beam 120 when wireless access point 101 is in reception mode.

In one embodiment, wireless access point 101 includes a plurality of digital-to-analog converters 101da1, 101da2, 101da3, 101daN associated with digital-signal processor 101dsp and connected, respectively, to (ii) a plurality of radio-frequency up-converters 101ud1, 101ud2, 101ud3, 101udN connected to said plurality of antennas 101 and respectively, said plurality of digital-to-analog converters and radio-frequency up-converters participate in said generation of beam 120 when wireless access point 101 is in transmission mode, by conveying beam 120 form digital-signal-processor 101dsp toward said plurality of antennas 101ant.

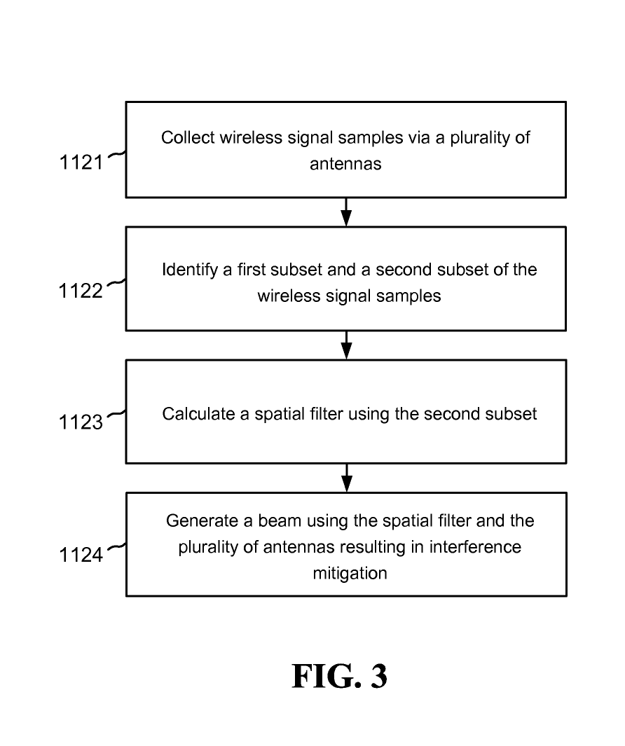

FIG. 3 illustrates one embodiment of a method for long-term interference mitigation in wireless local area networks. In step 1121, collecting via a plurality of antennas 101ant, by a transceiver 101 associated with a first wireless-local-area-network 100A, wireless signal samples associated with (i) transmissions 102t of at least a first transmitter 102 associated with said first wireless-local-area-network 100A, and (ii) transmissions 112t of at least a second transmitter 112 associated with a second wireless-local-area-network 100B. In step 1122, identifying, by said transceiver 101, (i) a first subset 1ss1 of said wireless signal samples as being associated with said first wireless-local-area-network 100A, and (ii) a second subset 1ss2 of said wireless signal samples as being non-associated with said first wireless local area network 100A. In step 1123, calculating a spatial filter, by said transceiver 101, using spatial information present in said second subset 1ss2 of said wireless signal samples. In step 1124, generating, by said transceiver 101, using said plurality of antennas 101ant and said spatial filter, a beam 120 operative to reduce wireless interferences generated by said second transmitter 112, thereby improving operation of said first wireless-local-area-network 100A. In one embodiment, said second subset 1ss2 of said wireless signal samples is arranged as an observation matrix comprising spatial information associated with said second transmitter 112. In one embodiment, said calculation includes: deriving a covariance from said observation matrix, adapting an existing codebook to an adapted codebook using said covariance, and using said adapted codebook as the spatial filter. In one embodiment, a minimum-mean-square-error technique is applied on said second subset 1ss2 of said wireless signal samples by said calculation of said spatial filter.

In one embodiment of said method for long-term interference mitigation, said first 100A and second 100B wireless-local-area-networks are wi-fi networks operating based on 802.11 standards. In one embodiment, said identification includes the step of determining that said second subset 1ss2 of said wireless signal samples is associated with an 802.11 media-access-control address 112mac that does not belong to any device currently associated with said first wireless-local-area-network 100A. In one embodiment, said determination includes the step of decoding, by said transceiver 101, said 802.11 media-access-control address 112mac, from portions 112 portion of said transmissions 112t of said second transmitter 112 that (i) are transmitted a short while following said second subset 1ss2 of said wireless signal samples, and (ii) contain said 802.11 media-access-control address. In one embodiment, said short while is shorter than 250 microseconds, thereby allowing said determination that said second subset 1ss2 of said wireless signal samples is associated with said 802.11 media-access-control address. In one embodiment, said transmissions 112t of said second transmitter 112 are (i) packetized, and (ii) include a consecutive series of a plurality of packets 112p1, 112p2, such that said second subset 1ss2 of said wireless signal samples is spread over said plurality of packets 112p1, 112p2, and said calculation of said spatial filter is done in a long-term fashion, by slowly adapting said spatial filter as new packets belonging to said plurality of packets arrive at said transceiver 101. In one embodiment, said spatial filter changes at a rate of less than one dB per one second for any direction covered, thereby resulting in said slow adaptation. In one embodiment, said codebook is adapted to said adapted codebook once every a time period that is greater than 1 milliseconds, thereby resulting in said slow adaptation. In one embodiment, said transmissions 102t of said first transmitter 102 are packetized and include at least one packet 102p1.

In one embodiment of said method for long-term interference mitigation, said plurality of antennas 101ant are arranged as a phased-array. In one embodiment, said second subset 1ss2 of said wireless signal samples includes of sets of signal samples, each of said set of signal samples taken from a different antenna of the phased-array 101ant. In one embodiment, said spatial information is associated with phase differences present among said sets of signal samples, and said phase differences are indicative of a direction 112d in which said second transmitter 112 is positioned relative to said transceiver 101.

In one embodiment of said method for long-term interference mitigation, said spatial information is associated with a direction 112d in which said second transmitter 112 is positioned relative to said transceiver 101, said beam 120 comprises a null 120n directed toward said direction 112d, thereby reducing wireless interferences generated by said second transmitter 112.

In one embodiment, transmitter 112 is a wireless access point, and both wireless access points 101, 112 are controlled by an access controller, such that each of said wireless access points transmits at a predefined time. In one embodiment, a timing of said calculation of said spatial filter or said covariance is controlled by said access controller. In one embodiment, at least one direction of interferences is acquired by wireless access point 101 by cooperating with wireless access point 112. In one embodiment, access controller 101 cooperates with access controller 112 either by communicating directly or via said access controller, in order to perform fine tuning of said spatial filter. In one embodiment, said fine tuning is done adaptively by sharing measured interference information between said wireless access points 101, 112. In one embodiment, said access controller allocates frequencies to said wireless access points 101, 112 according to said measured interference information. In one embodiment, said access controller sets transmission power levels of said wireless access points 101, 112 according to said measured interference information.

In one embodiment, a transceiver may be designed to receive spatially propagating signals in the presence of interference signals. If the desired signal and an interfering signal occupy the same temporal frequency band, then temporal filtering may not be able to separate signal from interference.

In one embodiment, implementing a temporal filter requires processing of data collected over a temporal aperture. In one embodiment, implementing a spatial filter requires processing of data collected over a spatial aperture such as a plurality of antennas that may be arranged in a phased array configuration.

In one embodiment, a single sensor such as an antenna, sonar transducer, or microphone collects impinging energy over a continuous aperture, providing spatial filtering by summing coherently waves that are in phase across the aperture while destructively combining waves that are not.

In one embodiment, an array of sensors provides a discrete sampling across its aperture. When the spatial sampling is discrete, the processor that performs the spatial filtering is termed a beamformer. A beamformer may linearly combine the spatially sampled time series from each sensor to obtain a scalar output time series in the same manner that an Finite Impulse Response (FIR) filter linearly combines temporally sampled data.

In one embodiment a system consists of N antenna elements. Each of the N antenna elements may be coupled with a radio frequency down converter and an analog-to-digital converter facilitating conversion of a specific frequency band into digital samples.

In one embodiment r[k] is the vector of N elements that is sampled at time k. In one embodiment the received samples at different sampling times may be aggregated into a matrix R=[r[k₁], r[k₂], . . . , r[kₗ]] with size N×l, which is one possible embodiment of an observation matrix.

In one embodiment, a relative spatial configuration of a plurality of antennas, such as antenna separation and relative location in 1D, 2D and 3D, may be utilized to generate a dictionary of beamformer coefficients, each is a vector of complex values with size N. Let vᵢ be a vector in the generated dictionary. The vector vᵢ may be designed to control phase shifts and amplitudes of N signals associated with said plurality of antennas, and hence may allow to generate a beam in a desired direction. In one embodiment the plurality of antennas are a unified linear array, that may be referred to as a phased array. In one embodiment the plurality of antennas are a circular array, that may be referred to as a phased array. In one embodiment the vector vᵢ is a steering vector to a direction i. In one embodiment the vector vᵢ is a steering vector multiplied by a weight, and hence may control a beam width and effective directivity. The vector vᵢ is one possible embodiment of a codebook.

In one embodiment, a covariance of a long-term interference and noise source is known at a receiver. In one embodiment a long-term statistics is computed for each direction of arrival separately. In one embodiment, a covariance at time instance s is estimated as

$${C}_{s} = \frac{1}{N} {\sum }_{k = 0}^{N - 1} r ( k ) {r ( k )}^{*} .$$

In one embodiment the covariance is estimated by aggregating several former covariance estimates recursively as

Cₛ=(1−α)Cₛ₋₁+αRR*,

wherein the factor α is designed to control a change rate of the covariance.

In one embodiment, given a covariance C, a codebook {vᵢ, i=0: M} is adapted to reduce an interference, and may be referred to as an adapted code book:

$${\tilde{v}}_{i} = \frac{{C}^{- 1} {v}_{i}}{{v}_{i}^{*} {C}^{- 1} {v}_{i}} .$$

In one embodiment a covariance is measured in a presence of interference only. A resulted Minimum Variance Distortionless Response (MVDR) adapted beamformer \tilde{v}ᵢ may be designed to minimized interference and noise while causing substantially no distortion to a desired signal with a direction of arrival that is matched to a direction of vᵢ. It is noted that a MVDR beam former does not require knowledge of directions of interferences for weight vector calculation; it requires only a direction of a desired signal and a covariance.

In one embodiment, a system utilizes reference signal, such as a known preamble, which is correlated to a desired signal and uncorrelated with interferences. In one embodiment, a Minimum Mean Square Error (MMSE) algorithm is used to compute spatial filters. In one embodiment a plurality of antennas outputs are compared with a reference signal, thus beams are produced in a direction of multipath signal matched with the reference signal.

In one embodiment, knowledge of a covariance and a vector z of cross correlation between a desired signal d and an input signal are assumed. In one embodiment, the vector z can be estimated as:

$$z = \frac{1}{N} {\sum }_{k = 0}^{N - 1} r [ k ] {d [ k ]}^{*} . ,$$

wherein r[k] is a vector of input samples, one per antenna element, and d[k] is a k-th sample from a desired signal. In one embodiment a desired signal d[k] is a known part of packets—a preamble as an example. In one embodiment a covariance is estimated over samples taken at a preamble time interval. A MMSE beamforer is computed as to minimize a mean squared error between a beamformer output and a desired signal. In one embodiment a MMSE weight vector is given by a solution to a Wiener-Hoff equation as:

\tilde{v}ᵢ=Cᵢ⁻¹zᵢ,

wherein Cᵢ is a covariance, while a desired signal is estimated to approach a plurality of antennas from direction I, and zᵢ is a corresponding vector of cross correlation.

In this description, numerous specific details are set forth. However, the embodiments/cases of the invention may be practiced without some of these specific details. In other instances, well-known hardware, materials, structures and techniques have not been shown in detail in order not to obscure the understanding of this description. In this description, references to “one embodiment” and “one case” mean that the feature being referred to may be included in at least one embodiment/case of the invention. Moreover, separate references to “one embodiment”, “some embodiments”, “one case”, or “some cases” in this description do not necessarily refer to the same embodiment/case. Illustrated embodiments/cases are not mutually exclusive, unless so stated and except as will be readily apparent to those of ordinary skill in the art. Thus, the invention may include any variety of combinations and/or integrations of the features of the embodiments/cases described herein. Also herein, flow diagrams illustrate non-limiting embodiment/case examples of the methods, and block diagrams illustrate non-limiting embodiment/case examples of the devices. Some operations in the flow diagrams may be described with reference to the embodiments/cases illustrated by the block diagrams. However, the methods of the flow diagrams could be performed by embodiments/cases of the invention other than those discussed with reference to the block diagrams, and embodiments/cases discussed with reference to the block diagrams could perform operations different from those discussed with reference to the flow diagrams. Moreover, although the flow diagrams may depict serial operations, certain embodiments/cases could perform certain operations in parallel and/or in different orders from those depicted. Moreover, the use of repeated reference numerals and/or letters in the text and/or drawings is for the purpose of simplicity and clarity and does not in itself dictate a relationship between the various embodiments/cases and/or configurations discussed. Furthermore, methods and mechanisms of the embodiments/cases will sometimes be described in singular form for clarity. However, some embodiments/cases may include multiple iterations of a method or multiple instantiations of a mechanism unless noted otherwise. For example, when a controller or an interface are disclosed in an embodiment/case, the scope of the embodiment/case is intended to also cover the use of multiple controllers or interfaces.

Certain features of the embodiments/cases, which may have been, for clarity, described in the context of separate embodiments/cases, may also be provided in various combinations in a single embodiment/case. Conversely, various features of the embodiments/cases, which may have been, for brevity, described in the context of a single embodiment/case, may also be provided separately or in any suitable sub-combination. The embodiments/cases are not limited in their applications to the details of the order or sequence of steps of operation of methods, or to details of implementation of devices, set in the description, drawings, or examples. In addition, individual blocks illustrated in the figures may be functional in nature and do not necessarily correspond to discrete hardware elements. While the methods disclosed herein have been described and shown with reference to particular steps performed in a particular order, it is understood that these steps may be combined, sub-divided, or reordered to form an equivalent method without departing from the teachings of the embodiments/cases. Accordingly, unless specifically indicated herein, the order and grouping of the steps is not a limitation of the embodiments/cases. Embodiments/cases described in conjunction with specific examples are presented by way of example, and not limitation. Moreover, it is evident that many alternatives, modifications and variations will be apparent to those skilled in the art. Accordingly, it is intended to embrace all such alternatives, modifications and variations that fall within the spirit and scope of the appended claims and their equivalents.

What is claimed is:

1. A method for mitigation of persistent interference in a wireless local area networks, comprising:
collecting via a plurality of antennas, by a transceiver associated with a first wireless-local-area-network, wireless signal samples associated with (i) transmissions of at least a first transmitter associated with said first wireless-local-area-network, and (ii) transmissions of at least a second transmitter associated with a second wireless-local-area-network;
identifying, by said transceiver, (i) a first subset of said wireless signal samples as being associated with said first wireless-local-area-network, and (ii) a second subset of said wireless signal samples as being non-associated with said first wireless local area network;
calculating a spatial filter, by said transceiver, using spatial information present in said second subset of said wireless signal samples; and
generating, by said transceiver, using said plurality of antennas and said spatial filter, a beam operative to reduce wireless interferences generated by said second transmitter, thereby improving operation of said first wireless-local-area-network.

2. The method of claim 1, wherein said second subset of said wireless signal samples is arranged as an observation matrix comprising spatial information associated with said second transmitter.

3. The method of claim 2, wherein said calculation comprises:
deriving a covariance from said observation matrix;
adapting an existing codebook to an adapted codebook using said covariance; and
using said adapted codebook as the spatial filter.

4. The method of claim 1, wherein a minimum-mean-square-error technique is applied on said second subset of said wireless signal samples by said calculation of said spatial filter.

5. The method of claim 1, wherein said first and second wireless-local-area-networks are wi-fi networks operating based on 802.11 standards.

6. The method of claim 5, wherein said identification comprises:
determining that said second subset of said wireless signal samples is associated with a 802.11 media-access-control address that does not belong to any device currently associated with said first wireless-local-area-network.

7. The method of claim 6, wherein said determination comprises:
decoding, by said transceiver, said 802.11 media-access-control address, from portions of said transmissions of said second transmitter that (i) are transmitted a short while following said second subset of said wireless signal samples, and (ii) contain said 802.11 media-access-control address.

8. The method of claim 7, wherein said short while is shorter than 250 microseconds, thereby allowing said determination that said second subset of said wireless signal samples is associated with said 802.11 media-access-control address.

9. The method of claim 5, wherein:
said transmissions of said second transmitter are (i) packetized, and (ii) comprising a consecutive series of a plurality of packets, such that said second subset of said wireless signal samples is spread over said plurality of packets; and
said calculation of said spatial filter is done in a long-term fashion, by slowly adapting said spatial filter as new packets belonging to said plurality of packets arrive at said transceiver.

10. The method of claim 9, wherein said spatial filter changes at a rate of less than one dB per one second for any direction covered, thereby resulting in said slow adaptation.

11. The method of claim 1, wherein said plurality of antennas are arranged as a phased-array.

12. The method of claim 11, wherein:
said second subset of said wireless signal samples comprises of sets of signal samples, each of said set of signal samples taken from a different antenna of the phased-array;
said spatial information is associated with phase differences present among said sets of signal samples; and
said phase differences are indicative of a direction in which said second transmitter is positioned relative to said transceiver.

13. The method of claim 1, wherein:
said spatial information is associated with a direction in which said second transmitter is positioned relative to said transceiver; and
said beam comprises a null directed toward said direction, thereby reducing wireless interferences generated by said second transmitter.

14. A wireless communication system operative to reduce interferences between different wireless local area networks, comprising:
a wireless access point operative to provide at least a portion of a first wireless-local-area-network; and
a plurality of antennas belonging to said wireless access point;
wherein said wireless access point is further operative to:
(a) collect, via said plurality of antennas, wireless signal samples associated with (i) transmissions of at least a first transmitter associated with said first wireless-local-area-network, and (ii) transmissions of at least a second transmitter associated with a second wireless-local-area-network,
(b) identify (i) a first subset of said wireless signal samples as being associated with said first wireless-local-area-network, and (ii) a second subset of said wireless signal samples as being non-associated with said first wireless local area network,
(c) calculate a spatial filter using spatial information present in said second subset of said wireless signal samples, and
(d) generate, using said plurality of antennas and said spatial filter, a beam operative to reduce wireless interferences generated by said second transmitter, thereby reducing interferences between said first and second wireless-local-area-networks.

15. The system of claim 14, wherein said second subset of said wireless signal samples is arranged as an observation matrix comprising spatial information associated with said second transmitter, and said calculation is operative to: (i) derive a covariance from said observation matrix, (ii) adapt an existing codebook to an adapted codebook using said covariance, and (iii) use said adapted codebook as the spatial filter.

16. The system of claim 14, wherein a minimum-mean-square-error technique is applied on said second subset of said wireless signal samples by said calculation of said spatial filter.

17. The system of claim 14, wherein said first and second wireless-local-area-networks are wi-fi networks operating based on 802.11 standards.

18. The system of claim 17, wherein said wireless access point is further operative to determine that said second subset of said wireless signal samples is associated with a 802.11 media-access-control address that does not belong to any device currently associated with said first wireless-local-area-network, thereby facilitating said identification.

19. The system of claim 17, wherein said second transmitter is a wireless wi-fi client.

20. The system of claim 17, wherein said second transmitter is a second wireless access point.

21. The system of claim 17, wherein said first transmitter is a wireless wi-fi client.

22. The system of claim 14, wherein said spatial information is associated with a direction in which said second transmitter is positioned relative to said wireless access point when said collection is made, and said generation results in a beam comprising a null directed toward said second transmitter, thereby reducing interferences between said first and second wireless-local-area-networks.

23. The system of claim 22, wherein said plurality of antennas are arranged as a phased array operative to (i) capture said spatial information via said wireless signal samples and (ii) generate said beam comprising said null.

24. The system of claim 14, wherein said first and second transmitters are operative to receive and decode wireless-local-area-network transmissions, and wireless-local-area-network transmissions of said wireless access point intended for said first transmitter are attenuated when received by said second transmitter due to said generation of said beam, thereby reducing interferences between said first and second wireless-local-area-networks.

25. The system of claim 14, wherein said wireless access point is operative to receive and decode wireless-local-area-network transmissions, and wireless-local-area-network transmissions of said second transmitter are attenuated when received by said wireless access point due to said generation of said beam, thereby reducing interferences between said first and second wireless-local-area-networks.

26. The system of claim 14, wherein said wireless access point further comprises a digital-signal-processor operative to perform said calculation and generate said beam using said spatial filter.

27. The system of claim 26, wherein said wireless access point further comprises a plurality of radio-frequency down-converters connected to said plurality of antennas respectively and operative to (i) collect said wireless signal samples and (ii) participate in said generation of said beam when said wireless access point is in reception mode.

28. The system of claim 27, wherein said wireless access point further comprises a plurality of analog-to-digital converters connected to said plurality of radio-frequency down-converters respectively and operative to (i) collect said wireless signal samples and (ii) feed said wireless signal samples into said digital-signal-processor.

29. The system of claim 27, wherein said wireless access point further comprises a plurality of analog-to-digital converters connected to said plurality of radio-frequency down-converters respectively and operative to participate in said generation of said beam when said wireless access point is in reception mode.

30. The system of claim 26, wherein said wireless access point further comprises: (i) a plurality of digital-to-analog converters associated with said digital-signal processor and connected, respectively, to (ii) a plurality of radio-frequency up-converters connected to said plurality of antennas respectively, said plurality of digital-to-analog converters and radio-frequency up-converters are operative to participate in said generation of said beam when said wireless access point is in transmission mode, by conveying said beam form said digital-signal-processor toward said plurality of antennas.
